(19) United States
(12) Patent Application Publication
(10) Pub. No.: US 2014/0082909 A1
(43) Pub. Date: Mar. 27, 2014

(54) ASSEMBLING TOOL

(71) Applicant: HON HAI PRECISION INDUSTRY CO., LTD., New Taipei (TW)

(72) Inventor: KAI-MING LU, New Taipei (TW)

(73) Assignee: HON HAI PRECISION INDUSTRY CO., LTD., New Taipei (TW)

(21) Appl. No.: 13/705,194

(22) Filed: Dec. 5, 2012

(30) Foreign Application Priority Data
Sep. 26, 2012 (CN) 201210362862X

(51) Int. Cl. B25B 11/00

(52) U.S. Cl. CPC B25B 11/00
USPC 29/281.1

(57) ABSTRACT

An assembling tool includes a supporting plate, a positioning plate extending up perpendicularly from a first end of the supporting plate, a U-shaped locking plate extending down from a second end of the supporting plate, and an operation portion attached to a bottom of the locking plate.

### BACKGROUND

1. Technical Field

The present disclosure relates to assembling tools and, particularly, to a tool for assembling photovoltaic sheets.

2. Description of Related Art

When assembling photovoltaic sheets to a supporting pole, the photovoltaic sheets need to be manually positioned, which is time consuming and inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a first embodiment of an assembling tool.

FIG. 2 is an isometric view of a second embodiment of an assembling tool.

FIGS. 3 and 4 show using states of the assembling tool of FIG. 1.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean “at least one.”

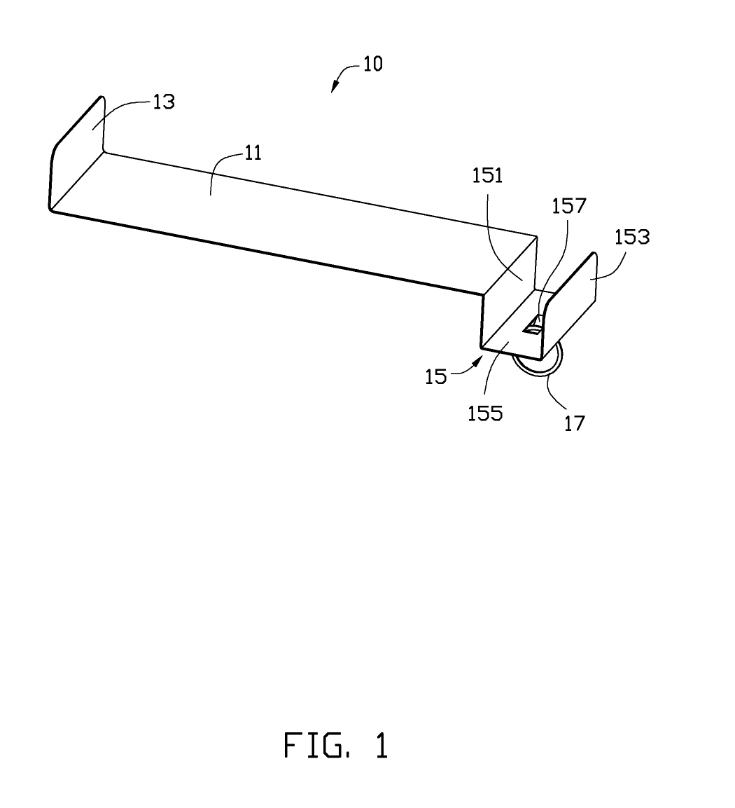

Referring to FIG. 1, a first embodiment of an assembling tool 10 includes a supporting plate 11, a positioning plate 13 extending up perpendicularly from a first end of the supporting plate 11, a U-shaped locking plate 15 extending down from a second end of the supporting plate 11, and an operation portion 17 attached to a bottom of the locking plate 15. In the embodiment, the operation portion 17 is a ring. The supporting plate 11, the positioning plate 13, and the locking plate 15 are integrally formed by bending a piece of resilient metal.

The locking plate 15 includes a first sidewall 151 extending down perpendicularly from the second end of the supporting plate 11, a second sidewall 153 parallel to the first sidewall 151, and a bottom wall 155 connected between bottoms of the first and second sidewalls 151 and 153. A bridge-shaped tab 157 extends down from the bottom wall 155. The operation portion 17 is connect to (encircles) the tab 157.

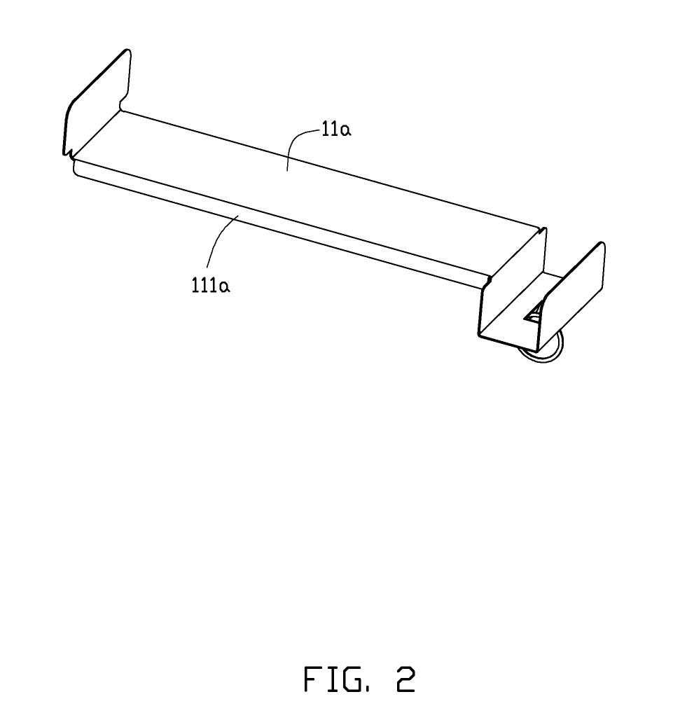

Referring to FIG. 2, in a second embodiment, the assembling tool 10 further includes a supporting plate 11a includes two flanges 111a extending down from opposite sides of the supporting plate 11a. The flanges 111a are used for reinforcing the supporting plate 11a.

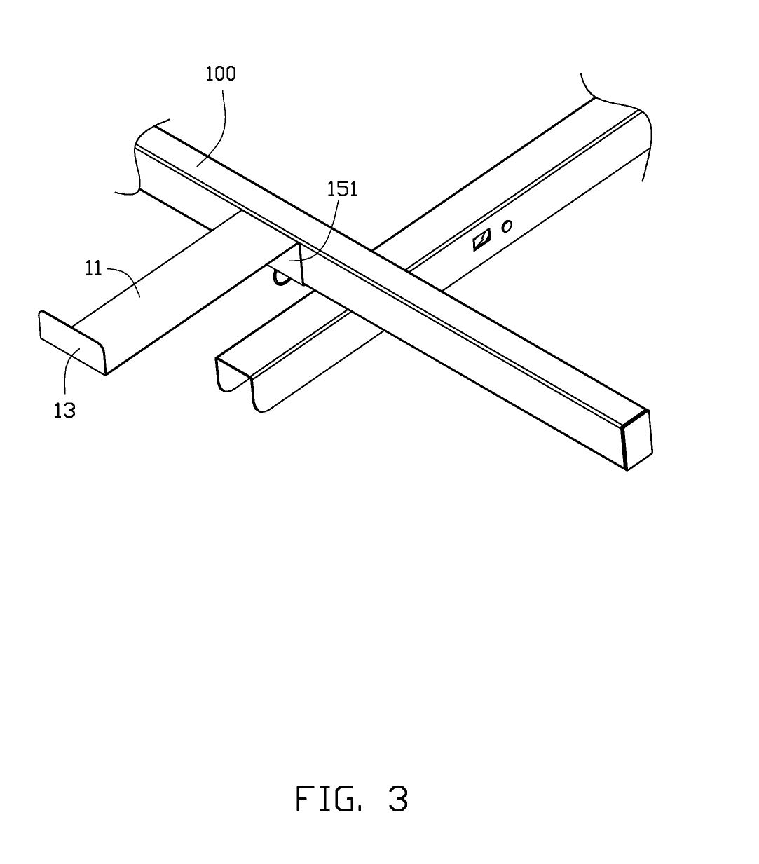

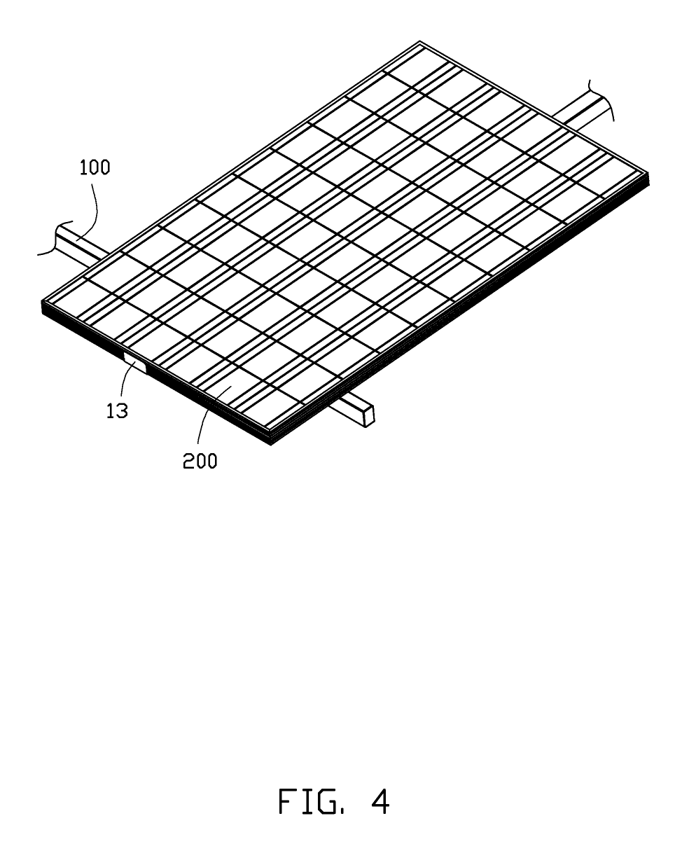

Referring to FIG. 3 and FIG. 4, in assembly of a photovoltaic sheet 200 on a bracket 100, the first embodiment of the assembling tool 10 is introduced as an example to explain the assembly. The locking plate 15 is locked to a lower portion of the bracket 100, with the first sidewall 151 and the second sidewall 153 sandwiching the bracket 100 to attach the locking plate 15 to the bracket 100. The photovoltaic sheet 200 is then set on the bracket 100. One edge of the photovoltaic sheet 200 abuts against the positioning plate 13. The supporting plate 11 supports the photovoltaic sheet 200. The photovoltaic sheet 200 is then fixed to the bracket 100.

The operation portion 17 is then operated to release the assembling tool 10 from the bracket 100 after the photovoltaic sheet 200 is fixed to the bracket 100.

In other embodiments, the length of the supporting plate 11 may be adjusted according to the distance between the edge of the photovoltaic sheet 200 and the bracket 100. The distance between the first sidewall 151 and the second sidewall 153 may be adjusted according to the width of the bracket 100.

In the embodiments, the assembling tool 10 is detachably attached to the bracket 100 to position the photovoltaic sheet 200, which makes assembling the photovoltaic sheet 200 to the bracket 100 more convenient and less time consuming.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An assembling tool, comprising:
a supporting plate;
a positioning plate extending up perpendicularly from a first end of the supporting plate;
a U-shaped locking plate extending down from a second end of the supporting plate opposite to the positioning plate; and
an operation portion attached to a bottom of the locking plate.

2. The assembling tool of claim 1, wherein the operation portion is a ring, a bridge-shaped tab extends down from the bottom of the locking plate, and the operation portion collars the tab.

3. The assembling tool of claim 1, wherein the supporting plate, the positioning plate, and the locking plate are integrally formed by bending a resilient metal piece.

4. The assembling tool of claim 1, wherein the locking plate comprises a first sidewall extending down perpendicularly from the second end of the supporting plate, a second sidewall parallel to the first sidewall, and a bottom wall connected between bottoms of the first and second sidewalls, the operation portion is attached to the bottom wall.
